(19) United States
(12) Patent Application Publication
(10) Pub. No.: US 2008/0253872 A1
(43) Pub. Date: Oct. 16, 2008

(54) Apparatus Supporting a Container on a Vehicle and Placing the Container Directly on a Ground Surface

(76) Inventor: David S. Tollefson, (US)

Correspondence Address: Ronald V. Davidge, 9900 Stirling Road, Suite 219, Cooper City, FL, 33024, US

(21) Appl. No.: 11/735,473

(22) Filed: Apr. 15, 2007

(51) Int. Cl. B60P 1/02

(52) U.S. Cl. 414/458

(57) ABSTRACT

A container held on a vehicle includes a central container portion with a central lower surface and a lateral lower surface at each side of the central container portion. The vehicle includes a “U”-shaped stationary frame, to which wheels are mounted, and a “U”-shaped moving frame, having longitudinal support members extending under the lateral lower surfaces to hold the container. The moving frame is lowered to set the container on a ground surface and raised to move the container into a position to be carried on the vehicle.

### BACKGROUND OF THE INVENTION

1. Field of the Invention

This invention relates to vehicles transporting and deploying containers, with the containers being set upon a ground surface for deployment.

2. Summary of the Background Art

Containers of various types are used for storage and hauling of materials, with the container being moved by a truck to be deployed on a ground surface. Typically such containers are carried on a bed or on a supporting frame of the truck, from which they must be slid or lifted for deployment. Other containers, used particularly for storing garbage are held at particular points, such as their corners or opposite sides, without being supported along their lengths. What is needed is a container and vehicle constructed to support the container along its length as it is picked up and carried, with the container being placed directly on the ground for deployment, and with the container being picked up directly from the ground, with a need to lift or slide the container from the support structure of the vehicle as the container is deployed or picked up being eliminated.

Various vehicles include vertically movable floor surfaces or tailgates that allow objects to be lifted and lowered as they are loaded or unloaded. However, such objects still need to be slid along or lifted off the floor surfaces or tailgates, which are moved into a position at or near the ground surface.

A number of patent documents describe a trailer having a “U”-shaped frame, in which a container is carried, together with a means for lifting the container from the ground For example, U.S. Pat. No. 3,958,707 describes such a trailer in which the container is suspended from three arms, pivoted at the frame and parallel to one another. A single arm at the front of the trailer is pivoted by an actuator. International Pat. App. WO 94/26554 describes such a trailer including four tower-like lifting mechanisms, each including a cable descending from a pulley, attached to the trailer frame near the four corners of a container suspended within the frame. U.S. Pat. App. Pub. No 2004/0223835 describes such a trailer in which the frame is provided with lifting mechanisms including hooks that attach within lifting holes along the sides of the container. European Pat. App 0040513 describes such a trailer in which the container is held, with pins at each of its upper corners, between scissor frames extending along each side. In the front of the trailer, a cylinder increases the distance between the two frame members of each scissor frame to lift the container.

Other patent documents describe versions of a vehicle that carries a hopper or ladle over a space within a “U”-shaped frame, through which material held within the hopper or ladle is poured. For example, U.S. Pat. No. 3,834,568 describes a portable bin carrier that carries the hopper over such a space, with the bin being supported by a pivoted lifting arm on each side. U.S. Pat. No. 4,105,130 describes a vehicle including a trailer transporting a ladle for molten slag, with a linkage mechanism for moving the ladle into a position for dumping its contents. U.S. Pat. No. 4.776,748 describes a vehicle including a trailer having a frame shaped as an upstanding inverted “U,” supporting a large hook for carrying a ladle of molten metal, while U.S. Pat. No. 4,556,356 describes a vehicle including a trailer having a “U”-shaped frame for supporting a container, with a dump-truck application being shown.

### SUMMARY OF THE INVENTION

In accordance with one aspect of the invention, apparatus is provided including a container and a vehicle, which may be self-propelled or pulled as a trailer. The container includes a central container portion, having a downward facing central lower surface, and a downward facing lateral lower surface extending along each side of the central container portion, being upwardly disposed from the central lower surface. The vehicle includes a stationary frame, formed as a first “U”-shaped structure extending in front of the central container portion and along each side of the central container portion to form a first opening through which the central container portion extends. The vehicle additionally includes a plurality of wheels rotatably mounted on the stationary frame to roll along a ground surface, with each of the wheels being disposed outwardly adjacent a side of the central container portion and below the lateral lower surface extending along the side of the central container portion. The vehicle additionally includes a longitudinal support member extending under the lateral lower surface at each side of the central container portion to hold the container and a moving frame attaching each of the longitudinal support members to move on the stationary frame along a preferred path of motion between a raised position and a lowered position. In the raised position, the longitudinal support member extending at each side of the central container portion holds the lateral lower surface extending above the longitudinal support member upward so that the central lower surface is disposed above and away from the ground surface. In the lowered position, the longitudinal support member extending at each side of the central lower surface is disposed below and away from the lateral lower surface extending above the longitudinal support member with the central lower surface resting on the ground surface.

Preferably, the moving frame is formed as a second “U”-shaped structure extending in front of the central container portion and along each side of the central container portion to form a second opening through which the central container portion extends. Such a moving frame includes a front moving frame structure extending between the longitudinal support members and in front of the central container portion. Preferably, the vehicle additionally includes an actuator moving the moving frame so that the longitudinal support members are moved in either direction between the raised and lowered positions.

The container may include an enclosed portion extending over each of the downward facing lower surfaces, and may additionally include an enclosed portion extending behind the longitudinal support members and the plurality of wheels.

According to a first embodiment of the invention, the vehicle additionally includes a plurality of rollers, rotatably attached to the stationary frame, and a plurality of inclined surfaces attached to the moving frame, extending parallel to one another, with each of the inclined surfaces being in contact with one of the rollers.

Alternately, according to a second embodiment of the invention, the vehicle additionally includes a plurality of cranks, each pivotally mounted to the stationary frame by a lower pin and to the moving frame by an upper pin. Each of the upper pins mounting one of the cranks is disposed at a common distance and at a common angle of inclination from the lower pin mounting the same crank. For example, two of the cranks are disposed opposite rear corners of the moving frame, while a front crank is disposed adjacent a midpoint of the front moving frame structure, with the actuator being pivotally attached to the front crank.

In accordance with another aspect of the invention, apparatus is provided including a container and a vehicle. The container includes a wall having a pocket extending inward in a first direction, inclined from the horizongal. The vehicle includes a horizontal support structure, a stationary frame, and a moving frame. The horizontal support structure holds the container in a raised position to be carried on the vehicle. The stationary frame includes a restraining bracket having a portion extending opposite the first direction. The moving frame moves the horizontal support structure to move the container into the raised position in the first direction. The pocket is moved over the portion of the restraining bracket extending opposite the first direction as the container is moved into the raised position. In this way, the container is prevented from sliding along the horizontal support structure as the container is held in the raised position.

### BRIEF DESCRIPTION OF THE FIGURES

FIG. 1 is a perspective view of a trailer built in accordance with a first embodiment of the invention holding a container additionally built in accordance with the a first embodiment of the invention;

FIG. 2 is a perspective view of the trailer of FIG. 1 with the container of FIG. 1 removed therefrom;

FIG. 3 is a fragmentary transverse cross-sectional view of the trailer of FIG. 1, taken as indicated by section lines 3-3 in FIG. 2;

FIG. 4 is a side elevation of the trailer of FIG. 1 holding the container of FIG. 1;

FIG. 5 is a side elevation of the trailer of FIG. 1 in position to begin a process of picking up the container of FIG. 1;

FIG. 6 is a fragmentary cross-sectional front elevation of the trailer of FIG. 1 holding the container of FIG. 1, taken as indicated by section lines 6-6 in FIG. 4;

FIG. 7 is a fragmentary cross-sectional side elevation of the trailer of FIG. 1 holding the container of FIG. 1, taken as indicated by section lines 7-7 in FIG. 6;

FIG. 8 is a fragmentary front elevation of the container of FIG. 1;

FIG. 9 is a fragmentary perspective view of the stationary frame of the trailer of FIG. 1, showing apparatus for mounting wheels thereon;

FIG. 10 is a side view of a vehicle built in accordance with a second embodiment of the invention holding a container also built in accordance with the second embodiment of the invention

FIG. 11 is a rear view of the vehicle of FIG. 10 holding the container of FIG. 10.

FIG. 12 is a side view of the vehicle of FIG. 10 with a moving frame therein in a lowered position; and

FIG. 13 is a rear view of a container built in accordance with a third version of the invention.

### DETAILED DESCRIPTION OF THE INVENTION

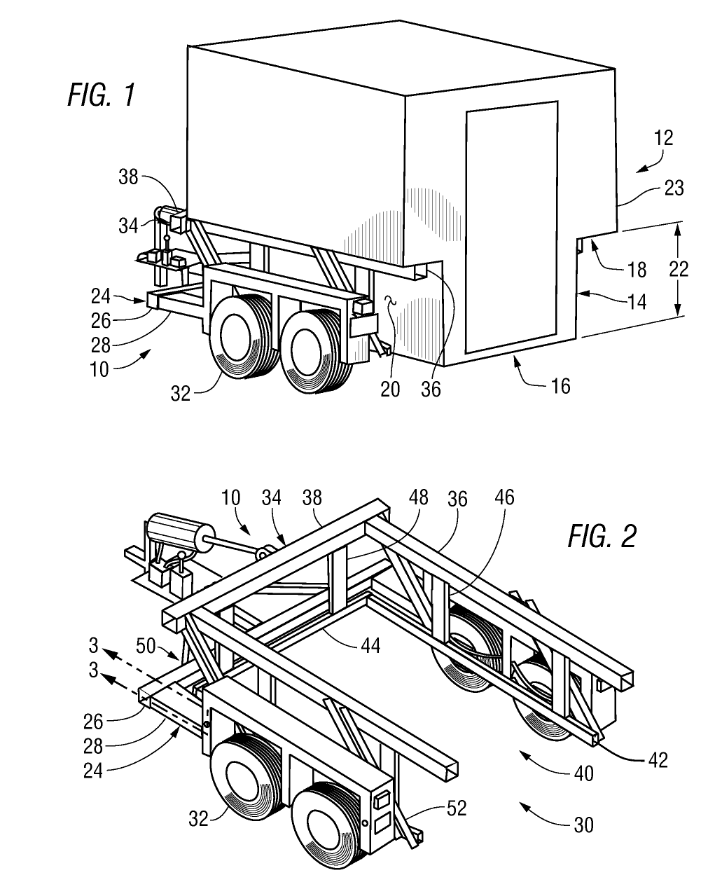

FIG. 1 is a perspective view of a trailer 10 built in accordance with a first embodiment of the invention, holding a container 12 additionally built in accordance with a first embodiment of the invention. The container 12 includes a central container portion 14, having a downward facing central lower surface 16, and a downward facing lateral lower surface 18, extending along each side 20 of the central container portion 14, being upwardly disposed from the central lower surface through a distance 22. The container 12 additionally includes an enclosed portion 23 extending over each of the downward facing lateral lower surfaces 18.

FIG. 2 is a perspective view of the trailer 10 with the container 12 removed therefrom. The trailer 10 includes a stationary frame 24, formed as a “U”-shaped structure extending in front of the central container portion 14. With the container 12 being held as shown in FIG. 1, a front stationary frame structure 26 of the stationary frame 24 extends in front of the central container portion 14, while a lateral frame structure 28 of the stationary frame 24 extends along each side 20 of the central container portion 14, forming an opening 30 through which the central container portion 14 extends. The vehicle additionally includes four wheels 32 rotatably mounted on the stationary frame to roll along a ground surface, with each of the wheels 32 being disposed outwardly adjacent a side 20 of the central container portion 14, again with the container 12 being held as shown in FIG. 1.

The trailer 10 additionally includes a moving frame 34, also formed as a “U”-shaped structure, including a longitudinal support member 36 extending under the lateral lower surface 18 at each side of the central container portion 14, again with the container 12 being held as shown in FIG. 1, and a front moving frame structure 38 extending in front of the central container portion to form an opening 40 through which the central container portion 14 extends. The moving frame 34 additionally includes a pair of lower longitudinal members 42, connected to one another by a lower front member 44 and to the longitudinal support members 36 by connecting post members 46. The lower front member 44 is additionally connected to the front moving frame structure 38 by connecting post members 48. The longitudinal support members 36 support the container 12 along its length as it is moved or lifted onto the trailer 10.

FIG. 3 is a fragmentary transverse cross-sectional view of the trailer 10, taken as indicated by section lines 3-3 in FIG. 2 to show a portion of a frame connecting structure 50 attaching the moving frame 34 to move on the stationary frame 24 along a preferred path of motion between a raised position and a lowered position. The frame connecting structure 50 includes four inclined channels 52, each of which extends downward and rearward from one of the longitudinal support members 36 to one of the lower moving frame members 42. The frame connecting structure 50 additionally includes a roller 54 rolling along an inclined surface 55 within each of the inclined channels 52, with the roller 54 being rotatably attached to one of the lateral frame structures 28 of the stationary frame 24 by means of a shaft 56, which is held in place by a number of clips 58, and upon which the roller 54 turns, preferably as a roller bearing.

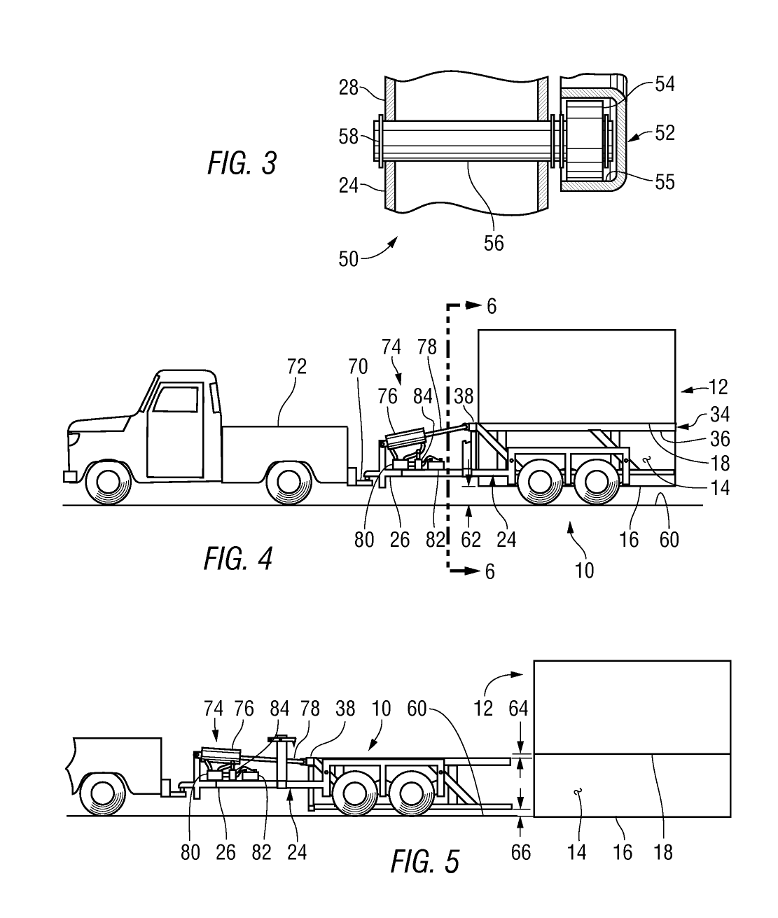

FIG. 4 is a side elevation of the trailer 10 holding the container 12, with the moving frame 34 in a raised position, providing for movement over a roadway. In the raised position, the longitudinal support member 36 extending at each side of the central container portion 14 holds the lateral lower surface 18 extending above the longitudinal support member 36 upward so that the central lower surface 16 is disposed above and away from the ground surface 60 through a traveling clearance distance 62.

FIG. 5 is a side elevation of the trailer 10 in position to begin a process of picking up the container 12, with the moving frame 34 in a lowered position. In the lowered position, the longitudinal support members 36 are disposed below and away from the lateral lower surface of the container 12 through a first clearance distance 64 with the central lower surface resting on the ground surface 60, and the moving frame 34 is disposed away from the ground surface 60 by a second clearance distance 66. In this way a convenient means is provided for placing the container 12 directly on the ground surface 60 without a need to slide the container 12 from the longitudinal support members 36 or from any other supporting surface of the trailer 10, and with disengagement occurring between the longitudinal support members 36 and the container 12 as the longitudinal support members 36 are moved downward.

The front stationary frame member 26 of the trailer 10 extends forward to provide for attachment to a trailer hitch 70 of a vehicle 72. The trailer 10 additionally includes an actuator 74 extending between the stationary frame 24 and the moving frame 34 to move the moving frame 34 in either direction between the raised position of FIG. 4 and the lowered position of FIG. 5. For example, the actuator 74 includes a hydraulic cylinder 76, pivotally attached to the front stationary frame member 26 of the stationary frame 24, moving a rod 78, pivotally attached to the front moving frame member 38 of the moving frame 34. Hydraulic fluid is then pumped into and from the hydraulic cylinder 76 by an electric pump 80 connected to a battery 82 through a control switch 84.

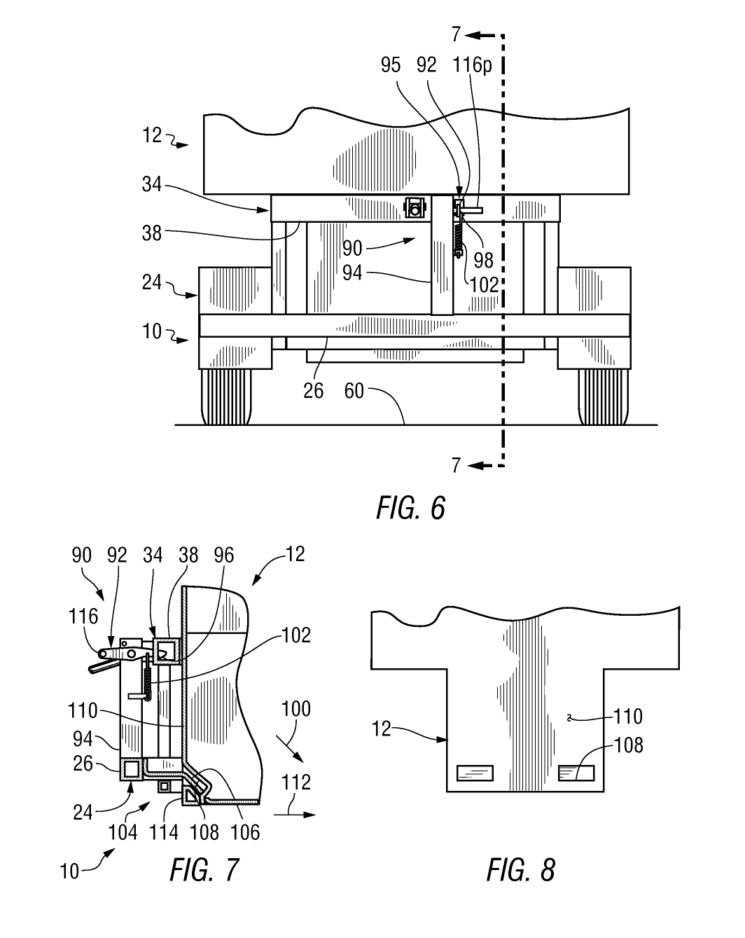

Methods for holding moving frame 34 of the trailer 10 in its raised position and for holding the container 12 in place on the moving frame 34 in its raised position will now be discussed, with reference being made to FIGS. 6-8. FIGS. 6 and 7 are fragmentary cross-sectional elevations of the trailer 10 holding the container 12, with FIG. 6 affording a front view taken as indicated by section lines 6-6 in FIG. 4, and with FIG. 7 affording a side view taken as indicated by section lines 7-7 in FIG. 6. FIG. 8 is a fragmentary front elevation of the trailer 12.

The trailer 10 includes frame latching apparatus 90 for holding the moving frame 34 in its raised position. This frame latching apparatus 90 includes a latching lever 92, pivotally mounted on a post 94 extending upward from the front stationary frame structure 26 of the stationary frame 24 to engage a slot 95 within the front moving frame structure 38 of the moving frame 34. A latching tooth 96 of the latching lever 92 engages a lower edge 98 of the slot 95, preventing movement of the moving frame 34 in the direction of arrow 100 from the raised position shown in FIGS. 6 and 7, with the latching lever 92 being held in this latched position by an extension spring 102.

The trailer 10 and container 12 additionally include load restraining apparatus 104 having a restraining bracket portion 106 extending in the direction of arrow 100 into each of a pair of pockets 108 formed to extend in the direction of arrow 100 within the front end surface 110 of the container 12. Each of the restraining brackets 106 is attached to the front stationary frame structure 26 of the stationary frame 24. As previously described in reference to FIGS. 2 and 3, the frame connecting structure 50.constrains movement of the moving frame 34 to movement in and opposite the direction of arrow 100, which is the direction in which the channels 52 extend. The restraining apparatus 104 is configured to take advantage of the angle between the direction of arrow 100 and the horizontal direction of arrow 112, since movement of the container 12 along the moving frame 34 is constrained to occur in and opposite the direction of arrow 112. As the moving frame 34 is moved into its raised position with the front surface 110 of the container 12 placed against the front moving frame structure 38, the pockets 108 move into place over the restraining brackets 106. Thereafter, as long as the moving frame 34 is held in its raised position, the restraining brackets 106 prevent horizontal movement, in the direction of arrow 112 of the container 12 along the moving frame 34. For example, a frame member 114 within the container 12 is provided to hold the pockets 108 in place.

Before the moving frame 34 can be lowered to place the container 12 against the ground surface 60, the frame latching mechanism 90 must be released by manually depressing an handle 116 so that the tooth 96 of the latching lever 92 is raised above the lower edge 98 of the slot 95. Then, with movement of the moving frame 34 in the direction of arrow 100, the pockets 108 are moved away from the latching brackets 106.

The trailer 10 and the container 12 may additionally be provided with further means for holding the container 12 in place on the moving frame 34, including, for example, pins, latching brackets, and tie-down straps.

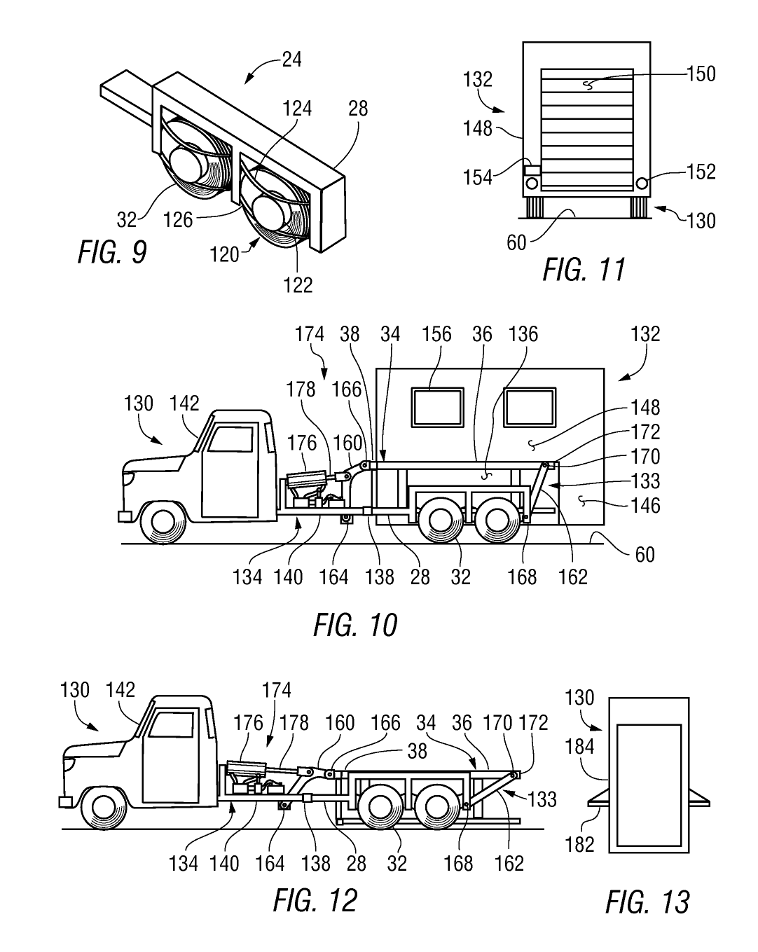

FIG. 9 is a fragmentary perspective view of the stationary frame 24 of the trailer 10, shown from inside and above the lateral frame structure 28 without the moving frame 34 being shown, so that the suspension apparatus 120 rotatably mounting the pair of wheels 32 is revealed. Each of the wheels 32 is rotatably mounted on a drum 122, which includes bearings, and which may also include a brake mechanism. Each of the drums 122 is attached to the lateral frame structure 28 by an upper leaf spring 124 and a lower leaf spring 126. The leaf springs 124,126 allow vertical movement of each drum 122 to accommodate bumps in the roadway while limiting twisting of the drum 122 about horizontal and vertical axes.

FIGS. 10 and 11 show a vehicle 130 built in accordance with a second embodiment of the invention holding a container 132 also built in accordance with the second embodiment of the invention, with FIG. 10 being a side elevation thereof, and with FIG. 11 being a rear elevation thereof.

The vehicle 130 is a self-propelled vehicle, such as a front-wheel drive truck that includes a stationary frame 134 having a lateral side frame structure 28, with elements similar to the elements described above in reference to the trailer 10 being given like reference numbers, extending along either side of an open area through which a central container portion 136 of the container 132 extends, with the stationary frame 134 thus including a “U”-shaped structure formed by the lateral side frame structures 28 and a front frame member 138. The stationary frame 134 additionally includes an intermediate frame member 140 extending along each side of the frame 134 from the transverse frame member 138 to an area under the truck cab 142. The vehicle 130 additionally includes a moving frame 34, which is generally as described above as a part of the trailer 10.

The container 132 includes an enclosed rear container portion 146, extending outward behind the longitudinal support members 36 and the wheels 32 to have the full width of the upper container portion 148. In comparison to the container 12 as described above, the greater width of the rear container portion 146 provides additional space within the container 132 and allows the use of a wider rear door 150. However, the container 132 has a need for running lights 152 providing tail light, turn indicator, and brake light functions, and for a separate license plate 154. The container 132 may additionally include one or more windows 156, facilitating its use as a portable office at various types of job sites.

FIG. 12 is a side elevation of the vehicle 130, with the container 132 removed therefrom and with the moving frame 34 in a lowered position, which is used to place the container 132 on the ground surface 60. The vehicle 130 additionally includes a frame connecting structure 133, by which the moving frame 34 is attached to the stationary frame 134 to move in either position between the lowered position of FIG. 12 and the raised position of FIGS. 10 and 11. The frame connecting structure 133 includes a front crank 160 and a pair of rear cranks 162. The front crank 160 is pivotally attached to the stationary frame 134 by a lower pin 164 and to the moving frame 34 by an upper pin 166.

Preferably, the front crank is disposed centrally between the two lateral frame structures 28, adjacent a midpoint in the front moving frame structure 38. Each of the rear cranks 162 is attached to one of the lateral frame structures 28 of the stationary frame 134 by a lower pin 168 and to the one of the lateral support members 36 by an upper pin 170. In this way, the moving frame 34 is movably attached to the stationary frame 134 centrally at the front of the moving frame 33 and near the opposite rear corners 172 of the moving frame 36. Preferably, the frame connecting structure 133 is arranged so that a line between the pins 164, 166 attaching the front crank 160 is parallel to a line between the pins 168, 170 attaching each of the rear cranks 162, so that a parallelogram linkage is formed, causing the rear cranks 162 to rotate with the front crank 160. In other words, each of the upper pins 166, 170 attaching a crank 160, 162 is separated from the lower pin 164, 168 attaching the same crank 160, 162 by a common distance at a common angle of inclination.

The vehicle 130 additionally includes an actuator 174 extending between the stationary frame 134 and the moving frame 34 to move the moving frame in either direction between the raised position of FIGS. 10 and 11 and the lowered position of FIG. 12. For example, the actuator 174 includes a hydraulic cylinder 176, pivotally attached to the stationary frame 134, driving a rod 178 pivotally attached to the moving frame 34 through the front crank 160. The vehicle 130 may additionally include means for latching the moving frame 34 in its raised position and for holding the container 132 in place on the moving frame 34, as described above in reference to FIGS. 6-8, with such latching means being applied either to the moving frame 34 itself or to the front crank 160.

FIG. 13 is a rear view of a container 180 built in accordance with a third version of the invention to include downward facing lateral lower surfaces 182 extending outward from sides 184 to be lifted and supported by the longitudinal support members 36 of the moving frame 34.

While the vehicle has been described and shown in terms of two embodiments, and while the container has been shown in terms of three embodiments, it is understood that these embodiments may be used interchangeably. For example, a container built in accordance with the second embodiment may be carried by a vehicle built in accordance with the first embodiment. It is further understood that various features described within the individual embodiments can be used within other embodiments. For example, the frame connecting structure 133 of the second embodiment may be used within a trailer otherwise constructed according to the first embodiment.

While the invention has been described and shown in it preferred embodiments, it is understood that this has been done only by way of example, and that various changes can be made without departing from the spirit and scope of the invention, as defined in the appended claims.

What is claimed is:

1. Apparatus comprising:
a container including a central container portion, having a downward facing central lower surface, and a downward facing lateral lower surface extending along each side of the central container portion, being upwardly disposed from the central lower surface; and
a vehicle including a stationary frame formed as a first “U”-shaped structure extending in front of the central container portion and along each side of the central container portion to form a first opening through which the central container portion extends, a plurality of wheels rotatably mounted on the stationary frame to roll along a ground surface, wherein each of the wheels is disposed outwardly adjacent a side of the central container portion and below the lateral lower surface extending along the side of the central container portion, and a longitudinal support member extending under the lateral lower surface at each side of the central container portion to hold the container, and a moving frame attaching each of the longitudinal support members to move on the stationary frame along a preferred path of motion between a raised position, in which the longitudinal support member extending at each side of the lateral lower surface holds the lateral lower surface extending above the longitudinal support member upward so that the central lower surface is disposed above and away from the ground surface, and a lowered position, in which longitudinal support member extending at each side of the central lower surface is disposed below and away from the lateral lower surface extending above the longitudinal support member with the central lower surface resting on the ground surface.

2. The apparatus of claim 1, wherein the moving frame is formed as a second “U”-shaped structure extending in front of the central container portion and along each side of the central container portion to form a second opening through which the central container portion extends, including a front moving frame structure extending between the longitudinal support members and in front of the central container portion.

3. The apparatus of claim 2, wherein the vehicle additionally comprises an actuator moving the moving frame so that the longitudinal support members are moved in either direction between the raised and lowered positions.

4. The apparatus of claim 3, wherein the vehicle additionally comprises::
a plurality of rollers rotatably attached to the stationary frame, and
a plurality of inclined surfaces attached to the moving frame, extending parallel to one another, wherein each of the inclined surfaces is in contact with a roller in the plurality of rollers.

5. The apparatus of claim 3, wherein
the vehicle additionally comprises a plurality of cranks, each pivotally mounted to the stationary frame by a lower pin and to the moving frame by an upper pin,
each of the upper pins mounting one of the cranks is disposed at a common distance from the lower pin mounting the crank and at a common angle of inclination from the lower pin mounting the crank.

6. The apparatus of claim 5, wherein:
two of the cranks are disposed adjacent opposite rear corners of the moving frame,
a front crank is disposed adjacent a midpoint of the front moving frame structure, and
the actuator is pivotally attached to the front crank.

7. The apparatus of claim 1, wherein
the longitudinal support members extend horizontally under the lateral lower surfaces of the container,
the longitudinal support members are moved into the raised position in a first direction inclined from the horizontal,
the stationary frame includes a restraining bracket having a portion extending opposite the first direction,
the container includes a pocket extending opposite the first direction,
the pocket is moved over the portion of the restraining bracket as the longitudinal members are moved into the raised position.

8. The apparatus of claim 1, wherein the container includes an enclosed portion extending over each downward facing lower surface.

9. The apparatus of claim 8, wherein the container includes an enclosed portion extending outward behind the longitudinal support members and the plurality of wheels.

10. The apparatus of claim 1, wherein the vehicle is a trailer further including a front stationary frame member extending between sides of the stationary frame in front of the central container portion, having an attachment portion extending forward as to provide for attachment to a trailer hitch.

11. The apparatus of claim 1, wherein the vehicle is self-propelled, further including:
a front stationary frame member extending between sides of the stationary frame in front of the central container portion;
a cab;
an intermediate frame member extending under the cab from each end of the lateral frame structure, and
a pair of driven front wheels.

12. Apparatus comprising:
a container including a central container portion, having a downward facing central lower surface, and a downward facing lateral lower surface extending along each side of the central container portion, being upwardly disposed from the central lower surface, wherein the container includes an enclosed portion extending over each downward facing lower surface; and
a vehicle including a stationary frame formed as a first “U”-shaped structure extending in front of the central container portion and along each side of the central container portion to form a first opening through which the central container portion extends, a plurality of wheels rotatably mounted on the stationary frame to roll along a ground surface, wherein each of the wheels is disposed outwardly adjacent a side of the central container portion and below the lateral lower surface extending along the side of the central container portion, and a longitudinal support member extending under the lateral lower surface at each side of the central container portion to hold the longitudinal support member.

13. The apparatus of claim 12, wherein the container additionally includes a an enclosed portion extending outward behind the longitudinal support members and the wheels.

14. The apparatus of claim 12 wherein the vehicle additionally includes a moving frame attaching each of the longitudinal support members to move on the stationary frame along a preferred path of motion between a raised position, in which the longitudinal support member extending at each side of the lateral lower surface holds the lateral lower surface extending above the longitudinal support member upward so that the central lower surface is disposed above and away from the ground surface, and a lowered position, in which longitudinal support member extending at each side of the central lower surface is disposed below and away from the lateral lower surface extending above the longitudinal support member with the central lower surface resting on the ground surface.

15. The apparatus of claim 14, wherein the moving frame is formed as a second “U”-shaped structure extending in front of the central container portion and along each side of the central container portion to form a second opening through which the central container portion extends, including a front moving frame structure extending between the longitudinal support members and in front of the central container portion.

16. The apparatus of claim 15, wherein the vehicle additionally comprises an actuator moving the moving frame so that the longitudinal support members are moved in either direction between the raised and lowered positions.

17. Apparatus comprising
a container including a wall having a pocket extending inward in a first direction, inclined from the horizontal;
a vehicle including a horizontal support structure holding the container in a raised position to be carried on the vehicle, a moving frame moving the horizontal support structure to move the container into the raised position in the first direction, and a stationary frame including a restraining bracket having a portion extending opposite the first direction, wherein the pocket is moved over the portion of the restraining bracket extending opposite the first direction as the container is moved into the raised position.

18. The apparatus of claim 17, wherein
the container includes a central container portion, having a downward facing central lower surface, and a downward facing lateral lower surface extending along each side of the central container portion, being upwardly disposed from the central lower surface,
a vehicle includes a stationary frame formed as a first “U”-shaped structure extending in front of the central container portion and along each side of the central container portion to form a first opening through which the central container portion extends, a plurality of wheels rotatably mounted on the stationary frame to roll along a ground surface, wherein each of the wheels is disposed outwardly adjacent a side of the central container portion and below the lateral lower surface extending along the side of the central container portion, and a longitudinal support member extending under the lateral lower surface at each side of the central container portion to hold the longitudinal support member to form the horizontal support structure, and a moving frame attaching each of the longitudinal support members to move on the stationary frame along a preferred path of motion between a raised position, in which the longitudinal support member extending at each side of the lateral ;lower surface holds the lateral lower surface extending above the longitudinal support member upward so that the central lower surface is disposed above and away from the ground surface, and a lowered position, in which longitudinal support member extending at each side of the central lower surface is disposed below and away from the lateral lower surface extending above the longitudinal support member with the central lower surface resting on the ground surface.

19. The apparatus of claim 18, wherein the moving frame is formed as a second “U”-shaped structure extending in front of the central container portion and along each side of the central container portion to form a second opening through which the central container portion extends, including a front moving frame structure extending between the longitudinal support members and in front of the central container portion.

20. The apparatus of claim 19, wherein the vehicle additionally comprises an actuator moving the moving frame so that the longitudinal support members are moved in either direction between the raised and lowered positions.
